(19) United States
(12) Patent Application Publication
(10) Pub. No.: US 2026/0222507 A1
(43) Pub. Date: Jul. 30, 2026

(54) PRINTING APPARATUS HAVING SECURITY COUNTERMEASURES CONTROL METHOD FOR PRINTING APPARATUS, AND RECORDING MEDIUM

(71) Applicant: CANON KABUSHIKI KAISHA, Tokyo (JP)

(72) Inventor: Akira Ishikawa, Kanagawa (JP)

(21) Appl. No.: 19/629,218

(22) Filed: Mar. 26, 2026

Related U.S. Application Data
(63) Continuation of application No. 18/405,024, filed on Jan. 5, 2024.

(30) Foreign Application Priority Data
Jan. 16, 2023 (JP) 2023-004572
Dec. 1, 2023 (JP) 2023-204263

(51) Int. Cl. H04N 1/00; G06F 3/12; H04L 9/40; H04N 1/32

(52) U.S. Cl. CPC H04N 1/00976; G06F 3/1238; G06F 3/1239; H04L 63/20; H04N 1/00466; H04N 1/0097; H04N 1/32673

(57) ABSTRACT

A printing apparatus provides a security countermeasure report screen displaying information indicating whether security countermeasures for predetermined targets of security protection have been taken respectively and displays a QR code including a link to a web content including content to guide a selection of a use environment. The printing apparatus sets, in response to receiving the selection of the use environment, values associated with the selected use environment and provides another screen displaying information of the selected use environment and an object for receiving a user operation for providing the security countermeasure report screen. After the values associated with selected use environment have been set and in response to reception of the user operation for the object on the another screen, information indicating that the security countermeasures have been taken based on the selection of the set values is displayed.

### BACKGROUND OF THE INVENTION

### Field of the Invention

The present invention relates to a printing apparatus that supports multiple security settings, and a control method for the printing apparatus, and a recording medium.

### Description of the Related Art

An information processing device with many functions has various settings for security. Various setting items are generally displayed grouped by function. For example, the settings for an encryption method for a communication path applied at the time of file transfer are displayed in the settings menu as a part of setting items of the file transfer function. Similarly, an encryption method applied at the time of e-mail transmission is displayed in the settings menu as a part of the e-mail function.

An example of a means for controlling scattered settings in an integrated manner is the technique of controlling the relevant encryption design according to the instruction of forbidding weak encryption (e.g., see Japanese Patent Application Laid-Open No. 2016-208448 A).

A set value for security of an information processing device is set in consideration of risks of security threats such as information leakage, falsification, and masquerading, and security protection targets such as ID protection, device protection, and network protection. It is difficult for users to ascertain the states of countermeasures for every security group, such as the states of threats, and the states of protection targets.

### SUMMARY OF THE INVENTION

The present invention helps users to easily ascertain the setting status of security countermeasures.

A printing apparatus according to the present invention has a reception means for receiving selection of a use environment of the printing apparatus, a setting means for setting multiple set values associated with the selected use environment in the printing apparatus, and a providing means for providing a report screen displaying whether a security countermeasure for protecting multiple targets of security protection has been taken for each of the targets based on whether each of the multiple set values for activating multiple security functions for protecting the multiple targets of security protection has been set in the printing apparatus.

Further features of the present invention will become apparent from the following description of exemplary embodiments with reference to the attached drawings.

### BRIEF DESCRIPTION OF THE DRAWINGS

FIG. 1 is a block configuration diagram illustrating a connection mode of a multifunction peripheral (MFP).

FIG. 2 is a block diagram illustrating details of the controller unit of the MFP.

FIG. 3 is a block diagram of software executed by the controller unit of the MFP.

FIG. 4 is a diagram illustrating an example of a menu screen according to a first embodiment.

FIG. 5 is a diagram illustrating an example of a recommended security setting screen according to the first embodiment.

FIGS. 6A and 6B are diagrams illustrating an example of a security setting summary screen according to the first embodiment.

FIG. 7 is a diagram illustrating another example of the security setting summary screen according to the first embodiment.

FIG. 8 is a flowchart showing processing of the MFP according to the first embodiment.

FIGS. 9A and 9B are diagrams illustrating an example of a security setting summary screen according to a second embodiment.

FIG. 10 is a flowchart showing processing of an MFP according to the second embodiment.

FIG. 11 is a diagram illustrating an example of a status dashboard screen according to a third embodiment.

FIGS. 12A and 12B are diagrams illustrating an example of a security status screen according to the third embodiment.

FIG. 13 is a flowchart showing processing of an MFP according to the third embodiment.

FIG. 14 is a flowchart showing processing of the MFP according to the third embodiment.

### DESCRIPTION OF THE EMBODIMENTS

### First Embodiment

Embodiments for implementing the present invention will be described in detail below. A multifunction peripheral (MFP) will be described below as an example of a printing apparatus. The present technology can be applied to general information processing devices including a printing apparatus. The embodiments described below are not intended to limit the invention according to the claims, and not all combinations of the features described in the embodiments are essential to the solution of the invention at all times.

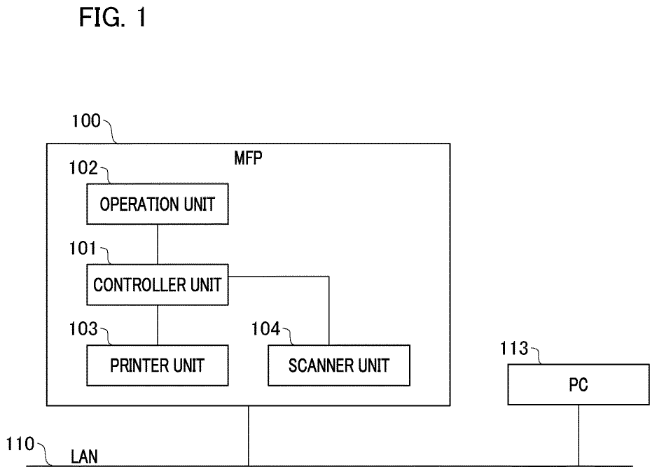

FIG. 1 is a block configuration diagram illustrating a connection mode of an MFP. Specifically, it is a block diagram illustrating a mode of connection of the MFP to a gateway and to a PC. The MFP 100 and the PC 113 are connected via a LAN 110.

The MFP 100 has an operation unit 102 that performs input and output with respect to a user. The MFP 100 has a printer unit 103 that outputs electronic data to paper media. The MFP 100 has a scanner unit 104 that converts paper media into loaded electronic data. The operation unit 102, the printer unit 103, and the scanner unit 104 are connected to the controller unit 101 and realize functions as a multifunction device according to control of the controller unit 101.

The PC 113 is a work terminal that transmits printing jobs to the MFP 100 or performs remote control. The number of PCs connected may be multiple.

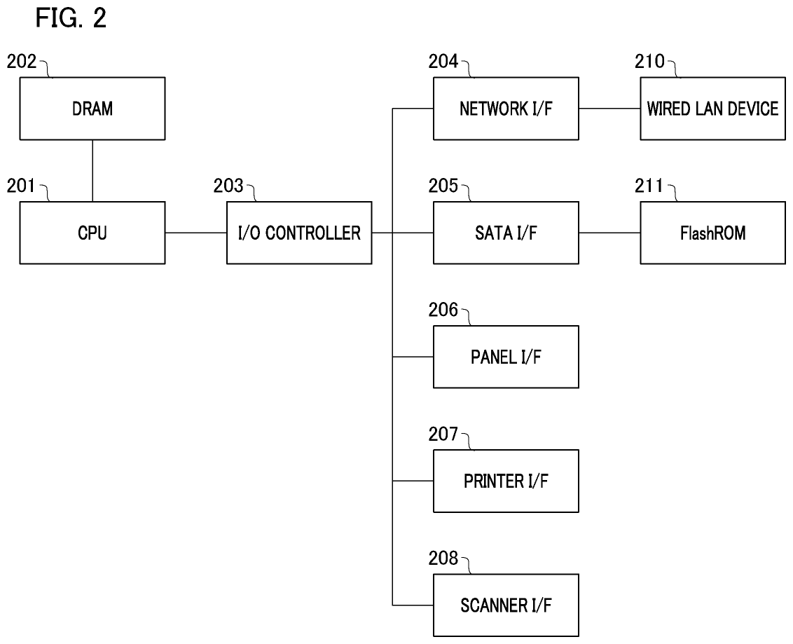

FIG. 2 is a block diagram illustrating details of the controller unit 101 of the MFP. A CPU 201 performs main arithmetic processing in the controller unit. The CPU 201 is connected to a DRAM 202 via a bus. The DRAM 202 is used by the CPU 201 as a working memory in which program data indicating arithmetic instructions and data to be processed are temporarily loaded in the process of arithmetic operations by the CPU 201. CPU is an abbreviation for central processing unit. DRAM is an abbreviation for dynamic random access memory.

The CPU 201 is connected to an I/O controller 203 via a bus. The I/O controller 203 performs input and output with respect to various devices according to instructions of the CPU 201. A SATA I/F 205 is connected to the I/O controller 203, and a FlashROM 211 is connected thereto after the SATA I/F. SATA is an abbreviation for serial advanced technology attachment. ROM is an abbreviation for read only memory. The CPU 201 uses the FlashROM 211 to store programs for realizing functions of the MFP. The CPU 201 further uses the FlashROM 211 to permanently store document files.

A network I/F 204 is connected to the I/O controller 203. A wired LAN device 210 is connected thereto after the network I/F 204. The CPU 201 controls the wired LAN device 210 via the network I/F 204 to realize communication on the LAN 110. A panel I/F 206 is connected to the I/O controller 203, and the CPU 201 realizes input and output with respect to the operation unit 102 via the panel I/F 206 for the user. A printer I/F 207 is connected to the I/O controller 203, and the CPU 201 realizes paper media output processing using the printer unit 103 via the printer I/F 207. A scanner I/F 208 is connected to the I/O controller 203, and the CPU 201 realizes scanning processing using the scanner unit 104 via the scanner I/F 208.

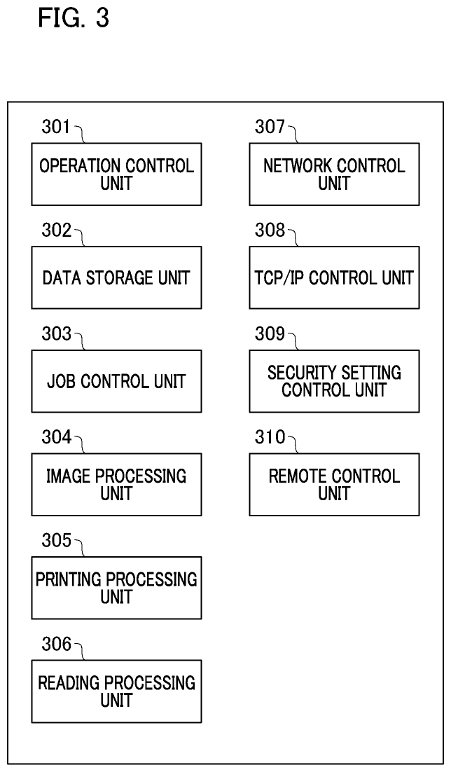

FIG. 3 is a block diagram of software executed by the controller unit 101 of the MFP. All kinds of software executed by the controller unit 101 are executed after the CPU 201 loads programs stored in the FlashROM 211 into the DRAM 202.

An operation control unit 301 executes processing of displaying a screen image on the operation unit 102 for the user, processing of detecting user operations, and processing associated with screen components such as a button displayed on the screen.

A data storage unit 302 performs storage and reading of data in the FlashROM 211 in response to a request from another control unit. For example, when a user changes any apparatus setting, the operation control unit 301 detects the input content from the user to the operation unit 102. Then, the data storage unit 302 saves the input content from the user as a set value in the FlashROM 211 in response to a request from the operation control unit 301.

A job control unit 303 controls job execution according to an instruction from another control unit. An image processing unit 304 processes image data in a form suitable for the application according to an instruction from the job control unit 303. A printing processing unit 305 prints an image on a paper media and outputs the paper media via the printer I/F 207 according to an instruction from the job control unit 303. A reading control unit 306 reads the placed original via the scanner I/F 208 according to an instruction from the job control unit 303. A network control unit 307 performs a network setting for an IP address, or the like by using a TCP/IP control unit 308 when the system activates or a setting change is detected according to a set value stored in the data storage unit 302. The TCP/IP control unit 308 performs processing of transmitting and receiving network packets via the network I/F 204 according to an instruction from another control unit.

A security setting control unit 309 specifies a setting item corresponding to a set value stored in the data storage unit 302. Specifically, the security setting control unit 309 specifies a correspondence relationship of to which setting item a security item is related or to which security threat each security setting item corresponds. The security setting control unit 309 manages information shown in Table 2, which will be described below, for specification. In addition, the security setting control unit 309 specifies, for each use environment, a security setting item and a set value for which setting is recommended. For specification, the security setting control unit 309 manages information shown in the correspondence table about use environments and settings excerpted from Table 1, which will be described below. The information is used to set a set value recommended in a selected use environment in the MFP 100 based on the selection of the use environment on a recommended security setting screen 501, which will be described below. In addition, the information is used to display security setting summary screens 601 and 701, which will be described below. Furthermore, the information shown in the correspondence table about settings and threats excerpted from Table 2 is used to display the security setting summary screens 601 and 701, which will be described below.

A remote control unit 310 performs control to operate the MFP 100 from the PC 113, instead of the operation unit 102. After the network control unit 307 detects communication including a display request or an operation request from the PC 113, the remote control unit 310 recognizes the communication content, and then makes a response to the display request or executes the operation request.

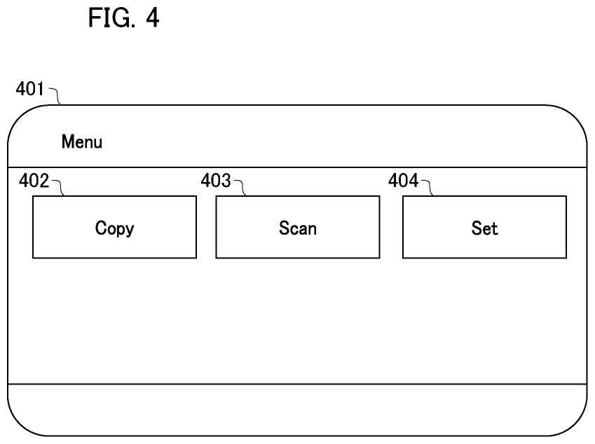

FIG. 4 is a diagram illustrating an example of a menu screen 401 according to a first embodiment. The menu screen 401 is displayed on the operation unit 102. A copy button 402, a scan button 403, and a setting button 404 displayed on the menu screen 401 are used to execute the corresponding functions of the MFP 100.

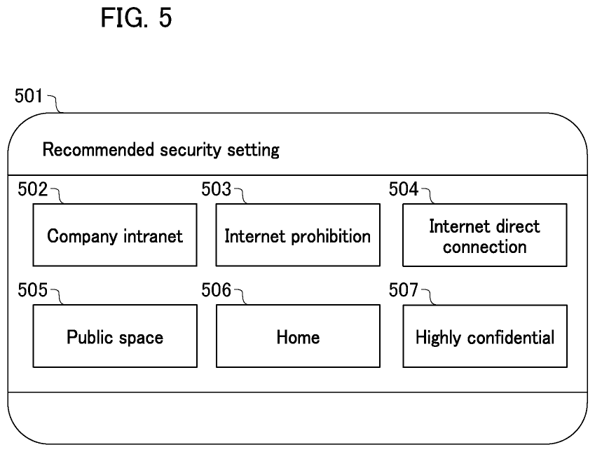

FIG. 5 is a diagram illustrating an example of the recommended security setting screen 501 according to the first embodiment. The recommended security setting screen 501 is displayed on the operation unit 102. The recommended security setting screen 501 is displayed by pressing the setting button 404 of the menu screen 401 and then selecting the recommended security setting screen from the displayed setting menu.

A use environment company intranet button 502 is a button for collectively setting a series of security settings suitable when the use environment is involved with a company intranet. A use environment internet prohibiting button 503 is a button for collectively setting a series of security settings suitable when the use environment is involved with prohibition of the Internet. A use environment internet direct connection button 504 is a button for collectively setting a series of security settings suitable when the use environment is involved with an Internet direct connection. A use environment public space button 505 is a button for collectively setting a series of security settings suitable when the use environment is involved with a public space. A use environment at-home button 506 is a button for collectively setting a series of security settings suitable when the use environment is a home. A use environment high-confidential button 507 is a button for collectively setting a series of security settings suitable when the use environment is an environment in which highly confidential information is treated.

When a user presses each button for the use environments, the data storage unit 302 records the information indicating which environment the use environment of the MFP 100 is. For example, when a user presses the use environment company intranet button 502, the data storage unit 302 records the information indicating the use environment of the MFP 100 is the company intranet. Then, the security setting control unit 309 sets a set value recommended for the company intranet environment in the MFP 100 by using the information of the correspondence table about the use environments being managed and settings. Specifically, it is recommended as excerpted from Table 1 that, in the company intranet environment, the set value for card authentication be ON and the set value for password authentication be ON. The security setting control unit 309 sets these set values in the MFP 100. The individual settings collectively made here can be individually changed on a setting screen, which is not illustrated.

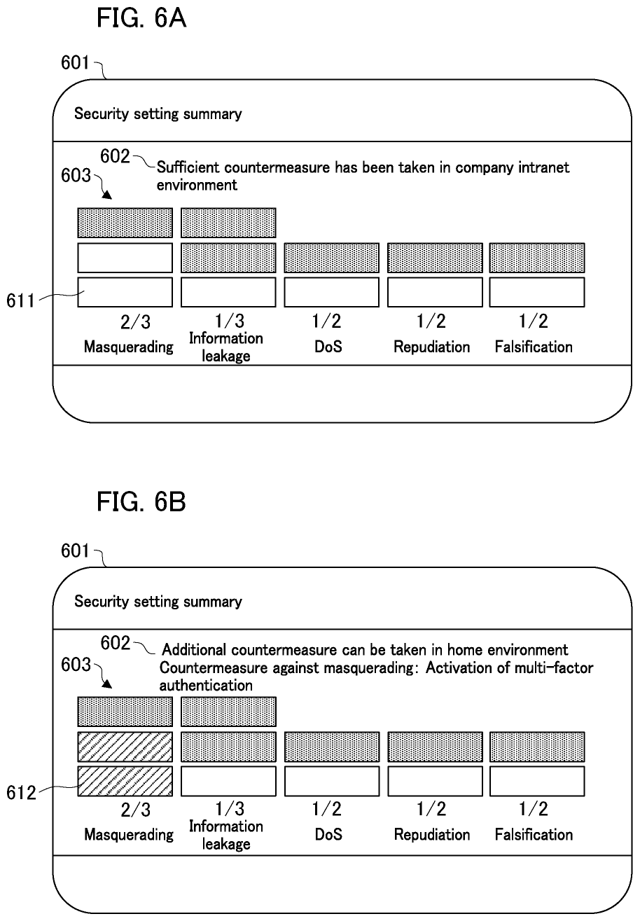

FIGS. 6A and 6B are diagrams illustrating an example of the security setting summary screen 601 according to the first embodiment. The security setting summary screen 601 is displayed on the operation unit 102. The security setting summary screen 601 is displayed by pressing the setting button 404 of the menu screen 401 and then selecting the security setting summary screen from the displayed setting menu.

FIG. 6A is an example of display immediately after the use environment company intranet button 502 is selected on the recommended security setting screen 501. FIG. 6B is an example of display after the use environment at-home button 506 is selected on the recommended security setting screen 501 and then the user makes changes in individual settings. Specifically, the drawing shows an example of display in a state in which the set values recommended for the home environment are collectively set by pressing the use environment at-home button 506 and then the user sets multi-factor authentication, which is a countermeasure against masquerading, to OFF.

An additional countermeasure presentation area 602 is an area in which an additional countermeasure recommended for the selected use environment is displayed. FIG. 6A shows an example of display to give a notification of sufficient countermeasures being taken against each threat. FIG. 6B shows an example of display when an additional countermeasure is recommended for masquerading among security threats. When additional countermeasures against multiple threats are recommended, all the countermeasures may be enumerated, or only one may be presented. The user may check the additional countermeasure presentation area 602 to ascertain the setting to be additionally changed in order to take sufficient countermeasures.

A threat countermeasure status presentation area 603 is an area in which a status of a security countermeasure against each threat is presented. The present embodiment is described with examples of bar graphs showing multiple stages (three stages). The number of multiple stages correspond to the number of settable setting items. The present embodiment takes five examples of security threats such as masquerading, information leakage, DoS, repudiation, and falsification. DoS is an abbreviation for Denial of Service. The threat countermeasure status presentation area 603 presents the number of settings for each security threat among security settings of the MFP 100 against security threats and also presents the number of activated settings among them. In other words, the threat countermeasure status presentation area 603 presents the number of set values that can be involved with each of multiple threats among multiple set values, and the number of set values for activation and the number of set values for inactivation. The threat countermeasure status presentation area 603 is displayed with numerical representations and graph representations. Here, “a set value for activation” means a set value that is likely to make security countermeasures activated, in other words, a set value recommended in terms of security. For example, “a set value for activation” is “ON” for “card authentication,” “ON” for “password authentication,” and “ON” for “multi-factor authentication” as shown in Table 1 and Table 2. Meanwhile, although not exemplified in Table 1 and Table 2, a setting item such as “use of a USB” or “display of a job history” is considered as a setting item related to security of the MFP 100. These items are setting items for security countermeasures against threats of information leakage. Both “use of a USB” and “display of a job history” are supposed to have OFF as set values in order to make security countermeasures activated. As described above, in the present embodiment, the set values that are OFF for “use of a USB” and OFF for “display of a job history” mean that the countermeasures are activated.

As a security setting for preventing “masquerading,” for example, a case in which the MFP 100 has a security setting of switching between activation and inactivation of three functions such as card authentication, multi-factor authentication, and banning simple passwords is assumed. When the security setting for the two functions of card authentication and banning simple passwords is activated, ⅔ is displayed as a numerical representation, and two bars out of three bars are displayed in an active color 611 as a bar graph representation. The active color 611 visually represents an active state of the counter measure, and is, for example, green. The active color 611 is not limited to green.

As described above, the threat countermeasure status presentation area 603 displays the number of present security settings and the number of activated security settings among them by using a graph. Thus, the user viewing the threat countermeasure status presentation area 603 can recognize how many security settings are present for each threat and how much the security settings are being utilized.

The color of the bar graph for masquerading in FIG. 6A is the active color 611 (e.g., green). On the other hand, the color of the bar graph for masquerading in FIG. 6B is displayed in a color 612 prompting a warning. The color 612 prompting a warning is, for example, yellow. The color 612 prompting a warning is not limited to yellow. In the example of FIG. 6B of the present embodiment, while three security settings are recommended for “masquerading” that is one of threats to the case in which the use environment is “at home,” only two setting items are activated. For this reason, additional countermeasures can be set for the threat “masquerading,” and a part of the bar graph is displayed in the color 612 prompting a warning.

By displaying the information related to the security countermeasures as described above, for example, a state in which sufficient countermeasures have been taken (FIG. 6A) and a state in which recommended countermeasures are not taken (FIG. 6B) are presented with respect to masquerading in visually different representations. That is, for a case in which all set values involved with a first threat among a group of set values are reflected and a case in which at least one of set values involved with the first threat among the group of set values is not reflected, the display color of the reflection status for the first threat is different. The user viewing the difference can intuitively ascertain that countermeasures against masquerading are insufficient. In addition, the user can ascertain whether sufficient countermeasures have been taken against each threat based on the use environment of the MFP 100. Even the same security settings are made in the MFP 100, whether the countermeasures taken against the threat “masquerading” are sufficient varies depending on the use environment of the MFP 100, for example, as illustrated in FIG. 6A and FIG. 6B. Due to the present invention, the user can easily ascertain the statuses of the countermeasures taken against every threat in each use environment as described above.

The security setting summary screen 601 of the present embodiment is an example of a reporting screen displaying the reflection status of the setting item involved with each of the multiple threats. In addition, the additional countermeasure presentation area 602 is an example of information indicating whether an additional countermeasure can be taken against each of the multiple threats.

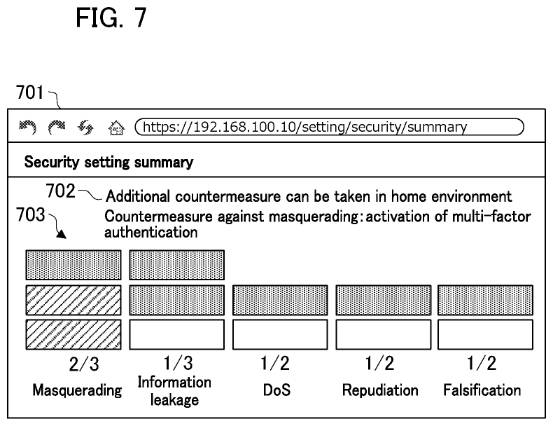

FIG. 7 is a diagram illustrating an example of a security setting summary screen 701 according to the first embodiment. FIG. 7 illustrates the security setting summary screen 701 displayed in the browser of the PC 113 when the MFP 100 is remotely controlled. Even in remote control, the same information as that in FIG. 6B is displayed as illustrated in FIG. 7. In remote control, necessary information (display of a URL in the present embodiment) is presented in addition to the display of FIGS. 6A and 6B. An additional countermeasure presentation area 702 is an area in which an additional countermeasure recommended for a selected use environment is displayed. A threat countermeasure status presentation area 703 is an area in which a status of a security countermeasure against each threat is presented.

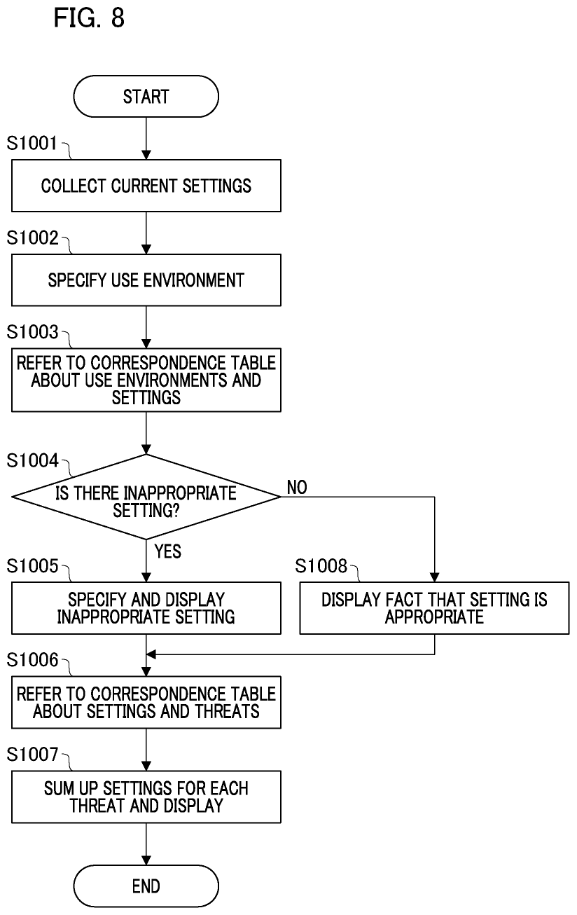

FIG. 8 is a flowchart showing processing of the MFP 100 according to the first embodiment. A processing flow in which the MFP 100 specifies a display item on the security setting summary screen 601 is described with reference to FIG. 8. The processing of FIG. 8 is performed after all programs recorded in the FlashROM 211 are loaded into the DRAM 202 and then the CPU 201 executes the programs as arithmetic processing. The present flow is started when the MFP 100 receives a request of displaying the security setting summary screen 601. Hereinafter, S is affixed to the beginning of each step.

In S1001, the MFP 100 collects current settings. The MFP 100 collects information of whether a setting item defined as a security setting by the security setting control unit 309 in advance is activated or inactivated from the data storage unit 302.

In S1002, the MFP 100 specifies the use environment. The MFP 100 retrieves the use environment of the MFP 100 selected by the user pressing a button on the recommended security setting screen 501 from the data storage unit 302. Here, in the present embodiment, the CPU 201 functions as a reception section that receives the selection of a use environment of the MFP 100 (information processing device).

In S1003, the MFP 100 refers to the correspondence table about the use environments and settings. The MFP 100 retrieves the recommended value of the security setting corresponding to the use environment specified in S1002 from the security setting control unit 309 and compares the value of the security setting with the security setting collected in S1001.

Table 1 shows the excerpt of the correspondence table about use environments and settings (setting items and set values). Table 1 shows recommended setting items and set values defined for the use environments in advance. As described above, the recommended setting items and set values are defined for each of the use environments. Because the settings to be controlled according to the use environments differ, only the settings to be controlled in each of the use environments are defined in the correspondence table about the use environments and settings. The excerpt of Table 1 exemplifies only three settings, which are card authentication, password authentication, and multi-factor authentication, only for the two environments, which are company intranet and home. The actual correspondence table about the use environments and settings serves as a list with hundreds of lines in which all security-related settings are defined for all six environments.

TABLE 1

| Use environments | Settings | Values |
|---|---|---|
| Company intranet | Card authentication | ON |
| Company intranet | Password authentication | ON |
| Home | Card authentication | ON |
| Home | Password authentication | ON |
| Home | Multi-factor authentication | ON |

In S1004, the MFP 100 checks whether there is an inappropriate setting. If it turns out that the set values do not match at all as a result of the comparison of S1003, the MFP 100 determines that there is an inappropriate setting, and performs S1005. If the set values match, the MFP 100 determines that there is no inappropriate setting, and performs S1008. For example, when the use environment specified in S1002 is the company intranet environment, the set values corresponding to the setting item “card authentication” and the setting item “password authentication” are compared to ascertain whether they have the set value ON among the current set values of the MFP 100 collected in S1001. If the set values of the two setting items are ON, in other words, if the set values match the set values shown in Table 1, the MFP 100 determines “there is no inappropriate setting.” In addition, when the use environment specified in S1002 is the at-home environment, for example, the set values corresponding to the setting items “card authentication,” “password authentication”, and “multi-factor authentication” are compared to ascertain whether they have set value ON among the current set values of the MFP 100 collected in S1001. For example, if the set value corresponding to at least one setting item does not match the recommended set value, like when “card authentication” and “password authentication” have ON, and “multi-factor authentication” has OFF, the MFP 100 determines “there is an inappropriate setting.”

In S1005, the MFP 100 specifies and displays the inappropriate setting. As a result of the comparison of S1003, the MFP 100 specifies and displays the different security setting from the recommended security setting as an inappropriate setting. In this case, the display is shown in the additional countermeasure presentation area 602 according to the display that there is an additional countermeasure. FIG. 6B is an example.

In S1006, the MFP 100 refers to the correspondence table about the settings and the threat. The MFP 100 retrieves each of the security setting items and the correspondence table about the security threats from the security setting control unit 309 to refer to.

Table 2 shows the excerpt of the correspondence table about the settings and the threats. The security settings related to the threats are defined in advance. The excerpt of Table 2 exemplifies only three settings, which are card authentication, password authentication, and multi-factor authentication. The actual correspondence table about the settings and the threats serves as a list with dozens of lines in which all security-related settings are defined.

TABLE 2

| Settings | Threats |
|---|---|
| Card authentication | Masquerading |
| Password authentication | Masquerading |
| Multi-factor authentication | Masquerading |

In S1007, the MFP 100 sums up and displays the settings for each threat. The MFP 100 sums up the security setting items collected in S1001 according to the correspondence table about the security threats referred to in S1006.

When masquerading is taken as an example of a threat, the three settings of card authentication, password authentication, and multi-factor authentication are present. Among these, the two setting items of card authentication and password authentication are set to ON. The number of settings corresponding to the threat and the number of settings activated in the apparatus among the aforementioned settings are summed up. Here, if there is an inappropriate setting as a result of the comparison in S1003, the color for the case of a warning (the color prompting a warning: yellow) is used in the display. On the other hand, if there is no inappropriate setting, the color for the normal case (active color: green) is used in the display. The information indicating which color is used in the display in which case is also specified as described above. The result is displayed in the threat countermeasure status presentation area 603, and then the present flow ends.

In S1008, the MFP 100 performs display to the effect that the setting is appropriate in the additional countermeasure presentation area 602. In the present embodiment, the CPU 201 functions as a presentation section that presents report screens. A report screen displays a reflection status of a group of set values corresponding to a selected use environment with respect to each of multiple threats involved with multiple set values set in the MFP 100 (information processing apparatus) based on the multiple set values.

According to the flow described above, the user can ascertain at a glance whether the status of the countermeasure taken in the security setting against the threat of interest is sufficient. In addition, if the status of the countermeasure taken in the security setting is insufficient, the user can figure out which additional countermeasure should be taken in the additional countermeasure presentation area 602.

### Second Embodiment

A second embodiment will be described below based on the drawings. The configuration of the second embodiment related to FIG. 1 to FIG. 5 is the same as that of the first embodiment. The same configuration as that of the first embodiment will be given the same reference numerals to avoid overlapping description. In the present embodiment, a degree of match to a use environment is displayed as security setting summary information. A degree of match is a degree (ratio) indicating a status in which a group of set values corresponding the use environment selected against each of multiple threats are reflected. Although a multifunction printer (multifunction peripheral or MFP) that is a printing apparatus will be described as an example, the present technique can be applied to general information processing apparatuses.

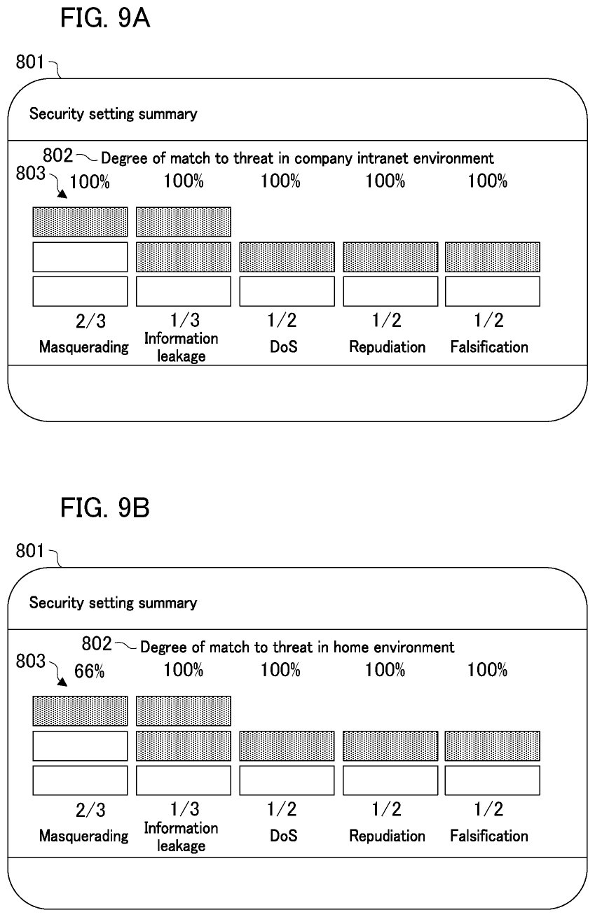

FIGS. 9A and 9B are diagrams illustrating an example of a security setting summary screen 801 according to the second embodiment. The security setting summary screen 801 is displayed on the operation unit 102. The security setting summary screen 801 is displayed by pressing the setting button 404 of the menu screen 401 and then selecting the security setting summary screen from the displayed setting menu.

FIG. 9A is an example of display immediately after the use environment company intranet button 502 is selected on the recommended security setting screen 501. FIG. 9B is an example of display after the use environment at-home button 506 is selected on the recommended security setting screen 501 and then the user makes changes in individual settings.

A match degree presentation area 802 is an area displaying how much the current set value matches the recommended set value with respect to each threat in the selected use environment. FIG. 9A shows an example of display to give a notification of sufficient countermeasures being taken against each threat. FIG. 9B shows an example of display when the set value is not recommended for masquerading among security threats. The user viewing the screen can intuitively ascertain whether the settings related to each of the threats are insufficient in the selected use environment.

A threat countermeasure status presentation area 803 is an area in which a status of a security countermeasure against each threat is presented. Although the threat countermeasure status presentation area 803 displays the same content as the threat countermeasure status presentation area 603, the match degree presentation area 802 displays a degree of match, and thus the control of changing colors of bar graphs may not be performed. The degree of match of 100% in the present embodiment corresponds to a bar graph displayed in the active color in the first embodiment.

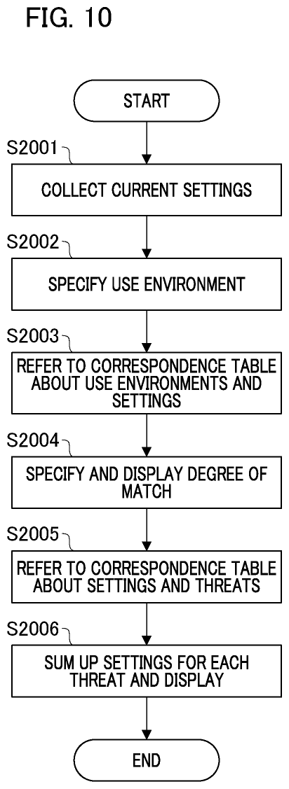

FIG. 10 is a flowchart showing processing of the MFP according to the second embodiment. A processing flow in which the MFP 100 specifies a display item on the security setting summary screen 801 is described with reference to FIG. 10. The processing of FIG. 10 is performed after all programs recorded in the FlashROM 211 are loaded into the DRAM 202 and then the CPU 201 executes the programs as arithmetic processing. The present flow is started when the MFP 100 receives a request of displaying the security setting summary screen 801.

In S2001, the MFP 100 collects current settings. The MFP 100 collects information of whether a setting item defined as a security setting by the security setting control unit 309 in advance is activated or inactivated from the data storage unit 302.

In S2002, the MFP 100 specifies the use environment. The MFP 100 retrieves the use environment of the MFP 100 selected by the user pressing a button on the recommended security setting screen 501 from the data storage unit 302.

In S2003, the MFP 100 refers to the correspondence table about the use environments and settings. The MFP 100 retrieves the recommended value of the security setting corresponding to the use environment specified in S2002 from the security setting control unit 309 and compares the value of the security setting with the security setting collected in S2001.

In S2004, the MFP 100 specifies and displays the degree of match. Description will be provided taking “home” as an example of the use environment and “masquerading” as an example of a threat. It is recommended in the present embodiment that the three setting items of card authentication, password authentication, and multi-factor authentication be activated. Among these, the two setting items of card authentication and password authentication are set to ON. Since the setting matches a setting with two recommended items among three items, the degree of match is specified as 66%. If all the recommended settings are satisfied, the degree of match is specified as 100%. There is a case with respect to each threat in which there is a setting other than a recommended setting for a selected use environment. In this case, the setting other than the recommended setting is not used to calculate a degree of match. For this reason, a degree of match never exceeds 100%. The degree of match obtained there is displayed in the match degree presentation area 802.

In S2005, the MFP 100 refers to the correspondence table about the settings and the threats. The MFP 100 retrieves the correspondence table about each of security setting items and the security threats from the security setting control unit 309 for reference.

In S2006, the MFP 100 sums up and displays the settings for each threat. The MFP 100 sums up the security setting items collected in S2001 according to the correspondence table about the security threats referred to in S2005. The result is displayed in the threat countermeasure status presentation area 603, and then the present flow ends.

According to the flow described above, the user can clearly ascertain that the status of the countermeasure taken in the security setting against the threat of interest is insufficient.

### Third Embodiment

A third embodiment will be described below based on the drawings. The configuration of the third embodiment related to FIG. 1 to FIG. 5 is the same as that of the first embodiment. The same configuration as that of the first embodiment will be given the same reference numerals to avoid overlapping description. In the present embodiment, whether a countermeasure function corresponding to a representative security protection item is activated is displayed as security setting summary information. Although a multifunction printer (multifunction peripheral or MFP) that is a printing apparatus will be described as an example, the present technique can be applied to general information processing apparatuses.

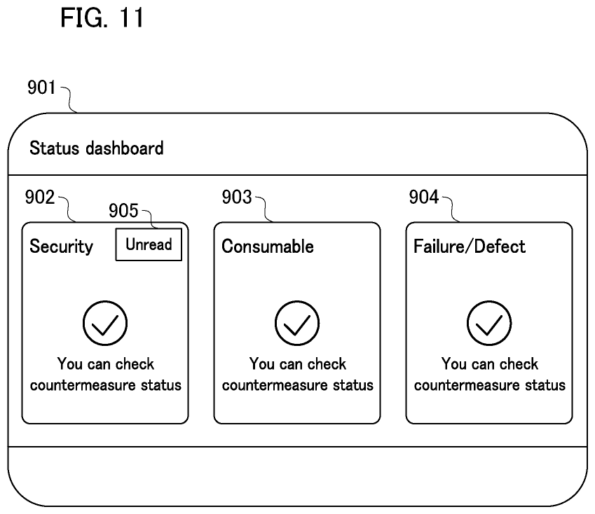

FIG. 11 is a diagram illustrating an example of a status dashboard screen 901 according to the third embodiment. The status dashboard screen 901 is displayed on the operation unit 102. The status dashboard screen 901 is displayed by pressing the setting button 404 of the menu screen 401 and then selecting the status dashboard screen from the displayed setting menu. The status dashboard screen 901 may be displayed by providing and pressing a status confirmation button on the menu screen 401.

A security status screen 951 can be displayed by pressing a security status button 902. A consumable status screen, which is not illustrated, can be displayed by pressing a consumable status button 903. The consumable status screen allows the user to check the remaining amount of consumables such as ink, toner, and printing paper that are consumables of the multifunction printer. A failure/defect status screen, which is not illustrated, can be displayed by pressing a failure/defect status button 904. The failure/defect status screen allows the user to check information about failure of components of the multifunction printer, and defects such as printing jams.

An unread mark 905 is display indicating there is unread information on various status screens. Although the case in which unread information is only on the security status screen 951 and the unread mark 905 is displayed only in the security status button 902 is illustrated in FIG. 11, if the buttons for consumable status and failure/defect status have unread information, the unread information is displayed in the buttons.

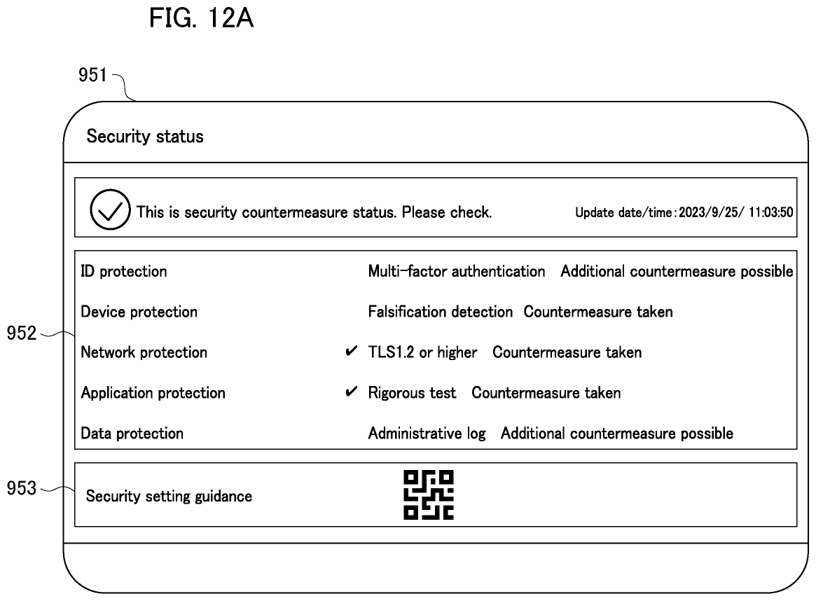

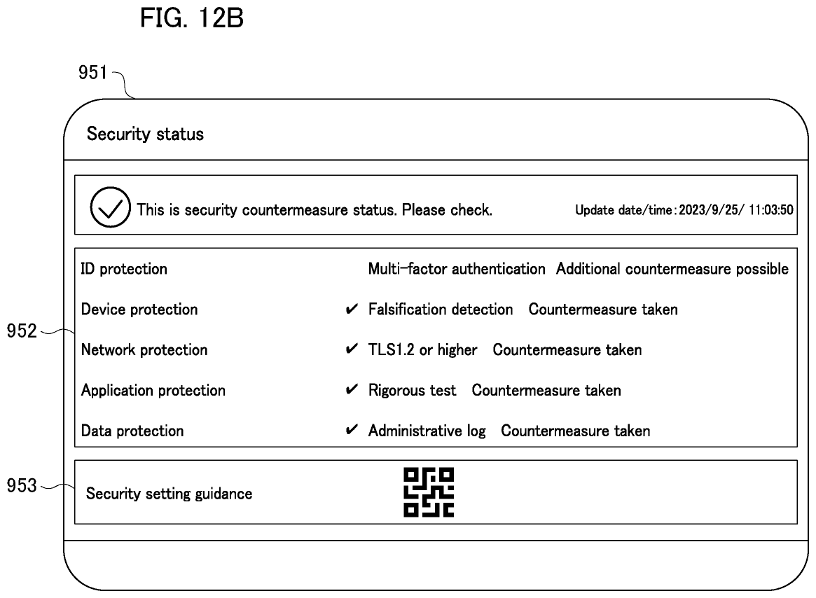

FIGS. 12A and 12B are diagrams illustrating an example of a security status screen 951 according to the third embodiment. The security status screen 951 is a screen on which a status of a countermeasure for a representative security protection item is displayed by the operation unit 102. The security status screen 951 is displayed by pressing the security status button 902 on the status dashboard screen 901. Another screen may be interposed between the status dashboard screen 901 and the security status screen 951. In other words, when it is detected that the user has pressed the security status button 902, the operation control unit 301 of the MFP 100 displays the other screen, which is not illustrated. The other screen includes a button for displaying the security status screen 951. When it is detected that the user has pressed the button, the operation control unit 301 displays the security status screen 951. Information indicating the use environment selected on the recommended security setting screen 501 may be displayed on the other screen. If the recommended security setting screen 501 does not receive the selection of the use environment, and a set value of the MFP 100 is changed from the default set value by the MFP 100 receiving a change in individual set values, information indicating that the settings have been manually customized may be displayed. In addition, information about the type of a network such as whether the network is connected to the Internet, information of whether protection by firewall is provided, and information about the type of document used such as whether a document used in the MFP 100 is general confidential information may be displayed.

FIG. 12A is an example of display at the time of factory shipment. FIG. 12B is an example of display after a security countermeasure is reinforced by selecting an appropriate use environment on the recommended security setting screen 501. In other words, multiple set values collectively set in the MFP 100 when a user selects each environment on the recommended security setting screen 501 include a set value for activating a falsification detection function and a set value for activating an audit log function which will be described below. A similar display state can be achieved by changing individual settings and reinforcing the security countermeasures, without using the recommended security setting screen 501.

A display area 952 is an area in which a status of an activated countermeasure function of the MFP 100 is displayed for each representative security protection item. Although the present embodiment has five representative security protection items such as ID, device, network, application, and data, other protection items may be included. A countermeasure function is defined for each item in advance, if the countermeasure function has been activated as a setting of the MFP 100, the fact that the countermeasure has been taken is displayed, if the countermeasure function has not been activated, the countermeasure function is indicated, and then the fact that an additional countermeasure can be set is displayed. In addition, in the examples illustrated in FIG. 12A and FIG. 12B, the display that the countermeasure has been taken is indicated with a check mark, and items for which security countermeasures have been taken and items for which additional security countermeasures can be set are displayed to be seen at a glance. The fact that the countermeasure has been taken may be displayed with, for example, a green check mark, and the fact that additional countermeasures can be set may be displayed with, for example, a grayed-out check mark.

In a setting guidance 952, description about protection items displayed in the display area 952 and a QR code indicating a link to the web content describing the procedure for setting the countermeasure functions corresponding to the protection items are displayed. The user can ascertain the web content by using a smartphone or the like to read the QR code of the setting guidance 952. The web content includes description about the procedure of a security countermeasure method using the recommended security setting screen 501 for easy use by the user.

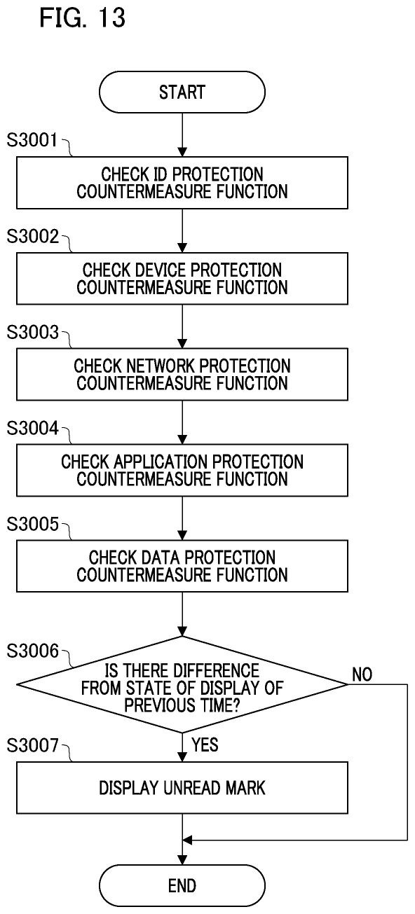

FIG. 13 is a flowchart showing processing of the MFP according to the third embodiment. A processing flow in which the MFP 100 controls the unread mark 905 on the status dashboard screen 901 is described with reference to FIG. 13. The processing of FIG. 13 is performed after all programs recorded in the FlashROM 211 are loaded into the DRAM 202 and then the CPU 201 executes the programs as arithmetic processing. The present flow is started when the MFP 100 receives a request of displaying the status dashboard screen 901. In the following description, when it is checked whether a function has been activated, the security setting control unit 309 determines whether the set value for activating the function has been set in the MFP 100. When the set value for activating the function is set in the MFP 100, it is determined that the function has been activated and the security countermeasure has been taken. When the set value for activating the function is not set in the MFP 100, it is determined that the function has not been activated and an additional countermeasure can be set, without taking the security countermeasure.

In S3001, the MFP 100 checks an ID protection countermeasure function. The MFP 100 causes the security setting control unit 309 to check whether the function of multi-factor authentication has been activated from the set value stored in the data storage unit 302. Here, although the activation is determined based on one setting of the function of multi-factor authentication, the determination may be comprehensively made by checking the activation state of user authentication that is the premise of the function of multi-factor authentication and the relevant settings such as the registration state of the user account. At this time, the setting for an additional countermeasure displayed in the display area 952 may be changed to other countermeasure content indicating that an additional countermeasure of user authentication can be set. In addition, when a cloud-type service is used as an authentication function, it may be checked by inquiring the input content of information about a setting to connect to the cloud service or an activation state with respect to the cloud service. When multiple authentication methods can be selected by a user, the authentication methods can be comprehensively checked by combining checking methods of each authentication method.

In S3002, the MFP 100 checks a device protection countermeasure function. The MFP 100 causes the security setting control unit 309 to check whether the function of falsification detection has been activated from the set value stored in the data storage unit 302. In S3003, the MFP 100 checks a network protection countermeasure function. The MFP 100 causes the security setting control unit 309 to check whether the version of transport layer security (TLS) is limited to 1.2 or higher from the set value stored in the data storage unit 302. The function may be determined not only by checking whether the function is activated as described above, but also by checking a restriction on the version of a specific function.

In S3004, the MFP 100 checks an application protection countermeasure function. Applications can be protected with a countermeasure of a program recorded in the FlashROM 211 having passed a rigorous security test. This is regardless of the settings of the MFP 100 and is information confirmed in the step in which the program is recorded in the FlashROM 211 at the time of factory shipment, and thus it is determined that countermeasures have been uniformly taken, without performing software confirmation in the present step. As described above, the determination may be made regardless of the use status of the MFP 100.

In S3005, the MFP 100 checks a data protection countermeasure function. The MFP 100 causes the security setting control unit 309 to check whether the function of administrative log has been activated from the set value stored in the data storage unit 302. Due to administrative logs, the history of operations such as uploading, downloading, and printing performed on confidential documents through the MFP 100 can be checked. This can be understood from the viewpoint of protection unique to printers specialized in handling business documents. In addition, when a highly advanced function of analyzing recorded logs is mounted, determination can be made based on the activation state of the log analysis function.

In S3006, the MFP 100 specifies whether there is a difference in status between the display of this time and the display of the previous time. The MFP 100 causes the security setting control unit 309 to acquire the status of the display of the previous time stored in the data storage unit 302 to compare the status with the confirmed results of S3001 to S3005. If there is not the status of the display of the previous time, the MFP determines that there is no difference. If there is a difference, the processing of S3007 is performed.

In S3007, the MFP 100 display unread mark. The MFP 100 displays the unread mark 905 on the status dashboard screen 901 displayed in the operation unit 102. The above flow enables the user to recognize that there is an unread status without checking the individual status screens.

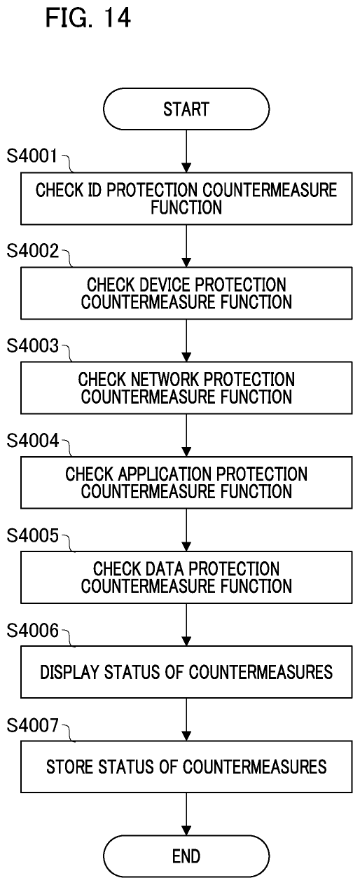

FIG. 14 is a flowchart showing processing of the MFP according to the third embodiment. A processing flow in which the MFP 100 controls the display area 952 on the security status screen 951 is described with reference to FIG. 14. The processing of FIG. 14 is performed after all programs recorded in the FlashROM 211 are loaded into the DRAM 202 and then the CPU 201 executes the programs as arithmetic processing. The present flow is started when the MFP 100 receives a request of displaying the security status screen 951.

In S4001, the MFP 100 checks an ID protection countermeasure function. The MFP 100 causes the security setting control unit 309 to check whether the function of multi-factor authentication has been activated from the set value stored in the data storage unit 302. In S4002, the MFP 100 checks a device protection countermeasure function. The MFP 100 causes the security setting control unit 309 to check whether the function of falsification detection has been activated from the set value stored in the data storage unit 302.

In S4003, the MFP 100 checks a network protection countermeasure function. The MFP 100 causes the security setting control unit 309 to check whether the version of TLS is limited to 1.2 or higher from the set value stored in the data storage unit 302. In S4004, the MFP 100 checks an application protection countermeasure function. The countermeasure of application protection is determined to have been uniformly taken because a program recorded in the FlashROM 211 having passed a rigorous security test is determined as a countermeasure.

In S4005, the MFP 100 checks a data protection countermeasure function. The MFP 100 causes the security setting control unit 309 to check whether the function of administrative log has been activated from the set value stored in the data storage unit 302. The steps from S4001 to S4005 may be a flow in which the content confirmed in steps from S3001 to S3005 is stored and read. In this case, prior to displaying of the security status screen 951, the status dashboard screen 901 needs to be displayed.

In S4006, the MFP 100 displays the status of countermeasures. The MFP 100 displays the confirmed results of S4001 to S4005 in the display area 952 on the security status screen 951 displayed in the operation unit 102. Specifically, as described above, the fact that a countermeasure has been taken for an item confirmed with an activated countermeasure function defined in advance for each item is displayed, and the fact that an additional countermeasure can be set is displayed for an item confirmed with no activated countermeasure. In S4007, the MFP 100 stores the status of countermeasures. The MFP 100 causes the security setting control unit 309 to record the status displayed in the present flow in the data storage unit 302. Specifically, the information indicating whether the countermeasure function defined in advance for each item has been activated is recorded. This recording is used to check the difference from the status of the display of the previous time in S3006.

According to the present embodiment, the above flow allows the user to check the status of the security countermeasures at a glance in terms of protection resources and simply feel safe.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-004572, filed Jan. 16, 2023, Japanese Patent Application No. 2023-204263, filed Dec. 1, 2023, which are hereby incorporated by reference wherein in their entirety.

1.-9. (canceled)

10. A printing apparatus comprising:
a memory storing instructions; and
a processor executing the instructions causing the printing apparatus to:
provide a security countermeasure report screen displaying information indicating whether security countermeasures for predetermined targets of security protection have been taken respectively, wherein the security countermeasure report screen further displays a QR code including a link to a web content including content to guide a selection of a use environment;
receive the selection of the use environment of the printing apparatus from among a plurality of use environments;
set, in response to the selection of the use environment, values associated with the selected use environment in the printing apparatus, wherein the values include a value to take a security countermeasure for one of the predetermined targets of security protection;
provide another screen displaying information of the selected use environment and an object for receiving a user operation for providing the security countermeasure report screen; and
after the values associated with selected use environment have been set in the printing apparatus and in response to a reception of the user operation for the object on the another screen, provide the security countermeasure report screen, displaying information indicating that the security countermeasures have been taken based on the selection of the set values.

11. The printing apparatus according to claim 10,
wherein the security countermeasure report screen displays information indicating that a countermeasure can be taken corresponding to a target for which a value to take a security countermeasure is not set in the printing apparatus.

12. The printing apparatus according to claim 10,
wherein the security countermeasure report screen displays a check mark to indicate that a security countermeasure for protecting the target has been taken.

13. The printing apparatus according to claim 10,
wherein the security countermeasure report screen is provided on an operation panel of the printing apparatus.

14. The printing apparatus according to claim 10,
wherein a status report screen including a first display item for displaying another screen is further provided.

15. ‘A control method for a printing apparatus, the control method comprising:
providing a security countermeasure report screen displaying information indicating whether security countermeasures for predetermined targets of security protection have been taken respectively, wherein the security countermeasure report screen further displays a QR code including a link to a web content including content to guide a selection of a use environment;
receiving the selection of the use environment of the printing apparatus from among a plurality of use environments;
setting, in response to the selection of the use environment, values associated with the selected use environment in the printing apparatus, wherein the values include a value to take a security countermeasure for one of the predetermined targets of security protection;
providing another screen displaying information of the selected use environment and an object for receiving a user operation for providing the security countermeasure report screen; and
after the values associated with the selected use environment have been set in the printing apparatus and in response to a reception of the user operation for the object on the another screen, providing the security countermeasure report screen, displaying information indicating that the security countermeasures have been taken based on the selection of the set values.

16. A non-transitory storage medium storing a control program of a printing apparatus causing a computer to perform each step of a control method, the control method comprising:
providing a security countermeasure report screen displaying information indicating whether security countermeasures for predetermined targets of security protection have been taken respectively, wherein the security countermeasure report screen further displays a QR code including a link to a web content including content to guide a selection of a use environment;
receiving the selection of the use environment of the printing apparatus from among a plurality of use environments; and
setting, in response to the selection of the use environment, values associated with the selected use environment in the printing apparatus, wherein the values include a value to take a security countermeasure for one of the predetermined targets of security protection;
providing another screen displaying information of the selected use environment and an object for receiving a user operation for providing the security countermeasure report screen; and
after the values associated with the selected use environment have been set in the printing apparatus and in response to a reception of the user operation for the object on the another screen, providing the security countermeasure report screen displaying information indicating that the security countermeasures have been taken based on the selection of the set values.

17. The printing apparatus according to claim 14,
wherein the status report screen further includes a second display item for displaying a use status of a consumable used in the printing apparatus.

18. The printing apparatus according to claim 14,
wherein the status report screen further includes an unread mark corresponding to the first display item in a case where the information indicating whether the security countermeasures for the predetermined targets of security protection have been taken respectively is different from the information specified when the first screen is displayed at a previous time.

19. The printing apparatus according to claim 10,
wherein the plurality of use environments includes at least one use environment from among a corporate intranet environment, an Internet direct connection environment, an Internet disabled environment, a home environment, a public space environment, and a highly confidential information management environment.

20. The printing apparatus according to claim 10,
wherein the predetermined targets of security protection include ID, a device, network, application and data.

21. The printing apparatus according to claim 10,
wherein percentages of setting items for which security countermeasures have been taken in predetermined items are displayed on the security countermeasure report screen.

22. The printing apparatus according to claim 10,
wherein bar graphs indicating a number of setting items for which security countermeasures have been taken in predetermined items are displayed on the security countermeasure report screen, and
wherein the bar graphs for which security countermeasures are insufficient are colored a warning color.
